(19) United States
(12) Patent Application Publication
(10) Pub. No.: US 2004/0242776 A1
(43) Pub. Date: Dec. 2, 2004

(54) Propylene polymer compositions having improved melt strength

(76) Inventors: Jeffrey J. Strebel, Cincinnati, OH (US); Sameer D. Mehta, Mason, OH (US); Jeffrey A. Jones, Morrow, OH (US)

Correspondence Address: EQUISTAR CHEMICALS, L.P., 11530 NORTHLAKE, CINCINNATI, OH, 45249, US

(21) Appl. No.: 10/447,367

(22) Filed: May 29, 2003

(51) Int. Cl. C08L 83/00

(52) U.S. Cl. 525/100; 525/63; 525/88

(57) ABSTRACT

Thermoplastic compositions having significantly improved melt strength are provided. The compositions are blends of propylene polymer and silane-containing polymer and may also contain mineral fillers and ethylene copolymer plastomers. Compositions of the invention are particularly useful for thermoforming applications.

### FIELD OF THE INVENTION

The present invention relates to propylene polymer compositions having improved melt strength. More specifically, the compositions are a blend of a propylene polymer and silane-containing polyolefin. Thermoformable compositions additionally containing mineral fillers and ethylene copolymer plastomers are also provided.

### DESCRIPTION OF THE PRIOR ART

Propylene polymer resins have enjoyed significant growth in recent years in view of the diverse resin types which are available. In addition to propylene homopolymer, numerous copolymers of propylene with ethylene and other α-olefins are now commercially produced. These include random copolymers, block copolymers and multi-phase polymer systems. This latter group of resins includes the so-called impact copolymers, thermoplastic polyolefins (TPOs), and thermoplastic elastomers (TPEs) which consist of a continuous phase of a crystalline polymer, e.g., highly isotactic propylene homopolymer, having a rubbery phase, e.g., ethylene-propylene copolymer, dispersed therein.

These resins are widely used in extrusion for the production of films, fibers and a wide variety of molded goods, such as bottles, hose and tubing, auto parts and the like. While it is necessary that these resins have sufficiently low melt viscosity under conditions of high shear encountered in the extruder, in order to have acceptable processability and achieve the high throughputs necessary for commercial operations, the resin must also have sufficient melt strength after extrusion to prevent sagging/distortion of the extrudate before it is cooled below the melt point. For example, a blow molding resin suitable for the production of shampoo bottles may not have sufficient melt strength for the production of one-gallon jugs where the parison is substantially larger and heavier.

High melt strength resins are particularly advantageous for the production of large thermoformed and blow molded articles, for extrusion coating and for foamed and sheet extrusions. With thermoforming, also referred to as vacuum forming, a plastic sheet is heated to a pliable state and then formed into the desired shape by forcing it against a mold using vacuum or positive air pressure. Articles can also be thermoformed by mechanical means, e.g., by the use of matched molds. As the plastic cools it retains the shape of the mold. While thermoforming provides significant processing advantages over injection molding for the fabrication of large parts, many propylene polymer compositions do not have sufficient melt strength for certain of these applications. Low melt strength can produce excessive sag during the heating and/or forming cycle.

U.S. Pat. No. 5,639,818 discloses a process for increasing the melt strength of polypropylene/polyethylene blends utilizing peroxide. For the process, a high propylene content polymer and non-crosslinked ethylene polymer which has been precontacted with an organic peroxide is melt-mixed at a temperature above the decomposition temperature of the peroxide. Alternatively, the peroxide may be adsorbed on a PP/PE blend prior to the melt-mixing. Non-crosslinked ethylene polymers disclosed for use in the process include copolymers of ethylene with silanes, vinyl acetate, methyl acrylate, n-butylacrylate and a, co-dienes.

In copending U.S. patent application Ser. No. 09/947,836 propylene polymer composites having improved melt strength are obtained by incorporating 0.5 to 12 weight percent (wt. %) organically modified clay and 0.5 to 12 wt. % compatibilizing agent with a propylene polymer base resin.

It would be highly advantageous if propylene polymer compositions having improved melt strength were available without the use of peroxide or the addition of modified clays and compatibilizng agents. It would be even more advantageous if these improved melt strength compositions included high rubber/elastomer content TPOs. These and other advantages are achieved with the compositions of the present invention which is described in detail to follow.

### SUMMARY OF THE INVENTION

The present invention provides propylene polymer compositions having significantly improved melt strength which makes them particularly well suited for thermoforming large parts. More specifically, the compositions are blends of a propylene polymer and a silane-functionalized polyolefin. One or more optional components, particularly, mineral fillers and ethylene copolymer plastomers may also be included in the formulation.

The compositions are comprised of 50 to 99.5 wt. %, based on the total composition, of a thermoplastic propylene homopolymer or copolymer or blend thereof and 0.5 to 50 wt. %, based on the total composition, of a silane-containing polyolefin polymer. Preferably, the propylene polymer has a melt flow rate-from 0.01 to 50 g/10 min, and the silane polymer is an ethylene polymer containing 0.1 to 20 wt. % vinyltrialkoxysilane of the formula H₂C═CHSi(OR)₃ where R is a C₁₋₄ alkyl group. Especially useful silane-containing polymers are polymers of ethylene and 0.25 to 7.5 wt. % vinyltrimethoxysilane or vinyltriethoxysilane. The silane comonomer is incorporated in the ethylene polymer by copolymerization or grafting.

Highly useful filled compositions will contain 2.5 to 35 wt. % mineral filler, preferably talc. It is even more useful if the talc has an average particle size between about 0.2 and 10 microns.

In another highly useful embodiment, the compositions contain from 1 to 35 wt. % of an ethylene-C₄₋₈ α-olefin plastomer having a density of 0.86 to 0.92 g/cm³ and melt index from 0.1 to 50 g/10 min. It is even more advantageous when the plastomer is a copolymer of ethylene with butene-1, hexene-1, octene-1, or mixtures thereof and has a density of 0.86 to 0.90 g/cm³ and melt index of 1 to 20 g/10 min.

Other optional ingredients in the compositions of the invention include dispersion aids and promoters.

### DETAILED DESCRIPTION

The thermoplastic propylene polymer compositions of the invention have a balance of properties making them suitable for a wide variety of applications. They exhibit good low temperature ductility and have a good balance of impact/stiffness. Additionally, the compositions of the invention exhibit significantly improved melt strength. This combination of properties makes the compositions especially well suited for use in thermoforming applications.

The compositions of the invention are blends of 50 to 99.5 wt. % propylene homopolymer or copolymer, or blend thereof, and 0.5 to 50 wt. % silane-containing copolymer. The compositions have melt flow rates (MFRs) from about 0.1 to 30 g/10 min and, more preferably, from 0.5 to 15 g/10 min. MFRs referred to herein are determined in accordance with ASTM D 1238 at 230° C. and 2.16 Kg load. In those instances where a melt index (MI) is specified, the MI is determined using test method ASTM D 1238 at 190° C. and 2.16 Kg load.

Particularly useful compositions contain 55 to 85 wt. % of the propylene polymer and 1 to 25 wt. % of the silane-containing polymer. Weight percentages of these and other blend components provided herein are based on the total weight of the composition.

The invention is adaptable for use with any of the widely known and commonly used thermoplastic propylene polymer resins which includes homopolymers, copolymers and blends thereof. Copolymers can include random, block, impact and TPO copolymers where propylene is the major, i.e., greater than 50 weight percent, monomer constituent. Comonomers can include ethylene and C₄₋₈ α-olefins. Copolymers of propylene and ethylene are particularly useful. The propylene polymer blends can be produced by physically blending two or more propylene polymers or they may be reactor-produced blends.

Useful propylene copolymers will contain 55 to 99.5 wt. % propylene and 0.5 to 45 wt. % ethylene. Even more preferred propylene polymer compositions comprise 65 to 99.5 wt. % propylene and 0.5 to 35 wt. % ethylene. These weight percentages are for the overall propylene polymer composition, so that if the composition is comprised of two or more different propylene polymer components, the monomer contents of the individual polymer components comprising the blend may be outside the specified ranges. MFRs of the propylene polymer will range from 0.01 to 50 g/10 min and, more preferably, from 0.1 to 30 g/10 min.

Propylene-ethylene copolymers comprised of two phases, i.e., a continuous phase of highly isotactic polypropylene homopolymer and a dispersed phase of rubber-like propylene-ethylene copolymer, are particularly useful. Depending on the relative proportion of the continuous and disperse phases, these compositions are classified as either impact copolymers or TPOs—the latter having a significantly higher rubber/elastomer content. Ethylene contents of these polymers will generally range from about 1 wt. % up to about 30 wt. %.

In a particularly useful embodiment of the invention, TPOs are used for the compositions of the invention. These are propylene-ethylene copolymers comprised of crystalline (propylene homopolymer) and amorphous or rubber (ethylene-propylene copolymer) phases. Ethylene contents of the TPO will range up to about 30 wt. %. Preferably, ethylene contents will be from 1 to 30 wt. % and, most preferably, from 6 to 22 wt. %. MFRs of the TPOs will range from 0.1 to 30 g/10 min and, more preferably, from 0.5 to 15 g/10 min. Ethylene-propylene rubber contents of the TPOs range from about 2 to about 50 wt. %.

TPOs employed for the invention are known and may be obtained by physically blending a propylene homopolymer with the requisite amount of ethylene-propylene rubber. They are, however, preferably produced using gas-phase, stirred-bed polymerization processes. These processes utilize two reactors connected in series and high activity supported transition metal catalysts. In such processes, reactor-made intimate mixtures of propylene homopolymer and ethylene-propylene copolymer are produced.

More specifically for such processes, propylene is homopolymerized in a first reactor at a temperature from 50° C. to 100° C. and pressure from 250 psig to 650 psig utilizing a titanium catalyst and an organoaluminum cocatalyst. Preferably the temperature in the first reactor will be from 50° C. to 90° C. and the pressure will range from 300 psig to 450 psig. The highly isotactic homopolymer produced in the first reactor is then directly fed to a second reactor which is maintained at 25° C. to 80° C. and 100 psig to 500 psig where propylene and ethylene are copolymerized in the presence of the homopolymer. The amount of ethylene employed in the second reactor is sufficient to produce the copolymer with rubber-like characteristics. Polymerization in the second reactor is generally accomplished without additional catalyst; however, it may be advantageous to introduce more catalyst to the second reactor. If more catalyst is employed, it can be the same as the catalyst used in the first polymerization or different. Preferably, the second polymerization reactor is operated at 40° C. to 70° C. and 100 psig to 350 psig.

High activity titanium catalysts activated by contact with organoaluminum cocatalysts are utilized for these polymerizations. The polymerizations are carried out in the substantial absence of liquid reaction medium and gas velocity within the stirred-bed is maintained below the onset of fluidization. Depending on their compositional makeup, gases can be recirculated through external heat exchanges for cooling or partially condensed. Cooled monomer is recirculated into the reactor and provides thermal control. Recirculated monomer vaporizes when it is introduced into the reactor so that polymerization occurs in the gas phase. In the preferred mode of operation, i.e., stirred, fixed-bed gas phase, the first and second reactors are fitted with spiral agitators to maintain a turbulent mechanically fluidized bed of polymer powder and prevent agglomeration.

Each reactor typically has its own control system(s) and is capable of independent operation. In the usual conduct of the process, propylene and ethylene monomers are passed through desiccant beds prior to introduction. Means are usually provided to individually meter propylene, ethylene, hydrogen for molecular weight control, catalyst and cocatalyst. This makes it possible to more readily control and maintain the desired reactor conditions. If desired, monomer may be injected into the recirculated gas stream for introduction into the system. Residence times in both reactors are on the order of 1 to 4 hours.

The use of dual or cascading reactors for the homopolymerization and copolymerization of propylene and ethylene to produce ethylene copolymers is known. Similarly, gas-phase polymerizations utilizing stirred, fixed beds comprised of small polymer particles are also known. For additional information regarding gas-phase polymerizations and a schematic flow diagram of the process, reference may be made to the article by Ross, et al., in Ind. Eng. Chem. Prod. Res. Dev., 1985, 24, pp 149-154, which is incorporated herein by reference.

Silane-containing polymers employed for the invention are ethylene polymers having a silane comonomer incorporated into the polymer chain by copolymerization or attached to the polymer chain by grafting. Highly useful silanes for the copolymerization and/or grafting are vinyltrialkoxysilanes of the formula:

H₂C═CHSi(OR)₃

where R is a C₁₋₄ alkyl group. Vinyltrimethoxysilane (VTMOS), i.e., where R is a methyl group, and vinyltriethoxysilane (VTEOS), where R is an ethyl group, are particularly useful. The amount of vinylalkoxysilane incorporated can range from 0.1 to 20 wt. % and, more preferably, will be in the range 0.25 to 7.5 wt. %. Useful silane-containing polymers have MIs from 0.05 to 50 g/10 min.; however, MIs preferably range from 0.1 to 20 g/10 min.

Silane grafted ethylene polymers are disclosed in U.S. Pat. No. 3,646,155 which is incorporated herein by reference. Silane-containing polymers obtained by copolymerizing ethylene with unsaturated alkoxysilanes are disclosed in U.S. Pat. Nos. 3,225,018 and 3,392,156 which are incorporated herein by reference.

One or more other olefin monomers may also be present with the ethylene and vinyltrialkoxysilane. α-Olefin comonomers are especially useful. When present, these comonomers may constitute up to 20 wt. % of the copolymer but are more preferably present in amounts less than 10 percent. Illustrative comonomers which can be present with the ethylene and vinyltrialkoxysilane include: α-olefins such as propylene, butene, hexene and octene; vinyl esters such as vinyl acetate and vinyl butyrate; carboxylic acids and their esters such as methacrylic acid, acrylic acid, methyl acrylate and methyl methacrylate; vinyl ethers such as methyl vinyl ether; acrylonitrile; and the like.

Graft-modified polyolefins are typically ethylene homopolymers or copolymers which can include high density polyethylene (HDPE), low density polyethylene (LDPE), linear low density polyethylene (LLDPE), medium density polyethylene (MDPE), very low density polyethylene (VLDPE) and ultra low density polyethylene (ULDPE). HDPE and LDPE grafted with VTMOS or VTEOS are particularly useful graft-functionalized silane-containing polyolefins.

In one highly useful embodiment of the invention a mineral filler is included with the propylene polymer and silane-containing copolymer. Mineral fillers are commonly employed in thermoformable compositions used for automotive applications to improve stiffness and other desirable properties. The filler will constitute 2 to 35 wt. % and, more preferably, 3 to 25 wt. % of the composition. Any of the conventional filler materials typically used with polyolefins can be employed. Such fillers can include calcium carbonate, clay, talc, kaolinite, wollastonite, pyrophillite, magnesium hydroxide, oxides of zinc and magnesium, silica and silicates, and the like.

The use of talc fillers is highly advantageous for the compositions of the invention. Useful talcs may be untreated or surface treated in accordance with known procedures. Talc surface treatments may include treatments with silanes, fatty acids, fatty acid metal salts or the like. Filler particle sizes may vary; however, it is generally preferred to utilize fillers having average particles sizes from about 0.2 to about 10 microns (μm). Talc having an average particle size between about 0.5 and 2.5 μm is particularly useful for formulating the thermoformable compositions of the invention.

In another highly useful embodiment, 1 to 25 wt. % and, more preferably, 3 to 15 wt. % of an ethylene polymer plastomer or mixture of plastomers is included in the formulation. Compositions formulated in this manner have even greater improvement of impact and melt strength.

Plastomers are ethylene based polymers, i.e., polymers having ethylene as the major constituent, prepared using metallocene catalysts. Metallocene or “single site” catalysts having at least one cyclopentadienyl or analogous ligand coordinated to a transition metal cation as well as plastomers produced using such catalyst systems are known. Metallocene catalysts and polymerization processes are described in U.S. Pat. Nos. 5,017,714 and 5,324,820 which are incorporated herein by reference.

Useful plastomers for the invention are copolymers of ethylene and C₄₋₈ α-olefin comonomers. Ethylene generally comprises from about 87 to about 97.5 mole % of the plastomer with the α-olefin comonomer(s) comprising from about 2.5 to 13 mole % of the plastomer. The plastomers have densities less than 0.92 g/cm³ and, more typically, from 0.86 to 0.92 g/cm³. Most preferably, plastomer densities will be from 0.86 to 0.90 g/cm³. Plastomer copolymers are described in more detail in U.S. Pat. No. 6,207,754 which is incorporated herein by reference.

The ethylene-α-olefin plastomers will have MIs from 0.1 g/10 min up to about 50 g/10 min. In a highly useful embodiment of the invention the plastomer MI will be from 1 to 20 g/10 min. Copolymers of ethylene with butene-1, hexene-1 and octene-1, or mixtures thereof, are highly useful plastomers. Such plastomers are available from commercial sources.

The compositions of the invention may also contain other additives commonly used for the formulation of propylene polymer resins. These additives include but are not limited to processing aids, antioxidants, heat stabilizers, UV absorbers, dispersing agents, crystallization accelerators, antistatic agents, lubricants, promotors and the like. The total amount of such additives will not exceed about 5 wt. % of the composition and, most preferably, will range between about 0.01 and 2.5 wt. %.

For example, in one highly useful embodiment of the invention, the compositions will contain 0.01 to 1 wt. % of a dispersing agent to facilitate uniform incorporation of the filler in the polymer matrix and insure production of a homogeneous blend. Conventional dispersing or blending aids can be employed for this purpose. Examples of useful dispersing agents include maleated polypropylenes; silanes; neoalkoxy titanates; fatty acid derivatives, such as metal soaps, amides and esters; low molecular weight aliphatic resins; and the like. Many of these additives have multiple functions and may also function as processing aids, compatibilizing agents, slip agents, lubricants, mold release agents, etc. for the resulting compositions. In one highly useful embodiment of the invention the dispersion agent is a blend of a fatty acid metal soap and an amide. Blending aids of this type are commercially available.

While it is not necessary, one or more other compounds, referred to as promotors, may also be included in the formulations. These compounds are referred to as promotors since it is believed they function to further enhance melt strength by promoting crosslinking reactions. Useful promotors include organic bases, carboxylic acids and organometallic compounds including organic titanates and complexes or carboxylates of lead, cobalt, iron, nickel, zinc and tin such as dibutyltin dilaurate, dioctyltin maleate, dibutyltin diacetate, dibutyltin dioctoate, stannous acetate, stannous octoate, lead naphthenate, zinc caprylate, cobalt naphthenate and the like. Tin carboxylates, especially dibutyltin dilaurate (DBTDL) and dioctyltin maleate, are particularly effective promotors. When employed, the promotors are used at levels from about 0.001 up to about 0.5 wt. % and, more preferably, from about 0.002 to about 0.2 wt. %.

The following examples illustrate the invention; however, those skilled in the art will recognize numerous variations which are within the spirit of the invention and scope of the claims. For example, similar results may be obtained using other propylene polymers and silane-containing polyolefins.

Melt strength was determined by measuring the amount of sag obtained with molded sheets at 210° C. For the tests, blends were prepared by mixing all of the components in a Brabender mixer (bowl temperature 210° C.) for 1 minute. The melt was then directly transferred to a 10×10×0.1 inch mold. Molded sheets (0.1 inch thick) were obtained by pressing between two plates at a pressure of 30 tons for 15 minutes. To determine melt strength, the molded sheet is clamped on a metal rack. Only the edges of the sheet contact the metal frame so that approximately a 7×7 inch area of the sheet is suspended above the bottom of an oven maintained at 210° C. The amount of the time required for the sheet to sag an inch is recorded. Times are also recorded for each additional 1 inch of sag up to a total sag of 6 inches. The test is terminated when either the sheet has sagged 6 inches or after 30 minutes.

### EXAMPLE 1

A mineral filled thermoformable composition was prepared. The blend contained 76.5 wt. % TPO (MFR 2 g/10 min; ethylene content 12%), 20 wt. % talc (median diameter 1.1 μm), 3 wt. % ethylene-VTMOS copolymer (density 0.923 g/cm³; MI 1.5 g/10 min; 1.7 wt. % VTMOS) and 0.5 wt. % commercial fatty acid metal soap/amide dispersion agent. Molded sheets prepared using the TPO/silane copolymer blend had significantly improved melt strength compared to a comparably formulated TPO composition without the ethylene-VTMOS copolymer. The mineral filled TPO/silane copolymer blend nearly completed the 30 minute test cycle. The sheet withstood heating for approximately 26 minutes before sagging 6 inches. Similar improvement in melt strength is observed when polypropylene and random propylene-ethylene copolymer are substituted for the TPO.

### EXAMPLES 2-4

Example 1 was repeated except that varying levels, ranging from 2.5 to 7.5 wt. %, of an ethylene copolymer plastomer were also included in the blends. The TPO, ethylene-VTMOS copolymer, talc and dispersion aid were the same as described for Example 2. The plastomer used was a commercially available ethylene-octene-1 copolymer (density 0.87 g/cm³; MI 5 g/10 min). Details of the formulations and test results obtained for each of the blends in the sag test are set forth in the table.

### EXAMPLES 5-7 And COMPARATIVE EXAMPLE A

A series of blends were prepared with varying levels of the ethylene-VTMOS copolymer. A comparable blend from which the ethylene-VTMOS copolymer was omitted was also included. The TPO, ethylene-VTMOS copolymer, plastomer, talc and dispersion aid used were the same as employed in Examples 2-4. Details of the formulations and sag test results are tabulated in the table. The improved melt strength achieved by incorporation of the silane-containing polyolefin is readily apparent by comparison with the comparative blend containing no silane copolymer.

### EXAMPLE 8

Example 6 was repeated except that the talc loading was increased to 30 wt. % and the TPO weight percentage proportionately reduced. The melt strength of the resulting blend was outstanding. Over the 30-minute test interval, the sheet formed from the inventive blend had not even sagged 1-inch. On the other hand, a comparative blend prepared without the ethylene-VTMOS copolymer reached the maximum sag of 6 inches in approximately 10 minutes.

### EXAMPLE 9

To demonstrate the ability to vary the blend components the following composition was prepared and evaluated. The blend was comprised of 67.25 wt. % TPO (MFR 1 g/10 min; ethylene content 15%), 5 wt. % ethylene-VTMOS copolymer, 7.5 wt. % plastomer and 20 wt. % talc. For this blend 0.25 wt. % of a promotor concentrate (1.4% dibutyltindilaurate in LDPE) was also included. After 30 minutes at 210° C. the molded sheet prepared with this blend sagged approximately 5 inches. By increasing the amount of ethylene-VTMOS copolymer in the blend to 10 wt. % and increasing the promotor concentrate level to 0.5 wt. % the melt strength was significantly increased so that after 30 minutes only about 2 inches sag was observed.

### EXAMPLE 10

The formulation of Example 4 was repeated except that the TPO had a MFR 2 g/10 min and an ethylene content of 5%. The formulation, which had an MFR of 2.5 g/10 min, exhibited superior melt strength. In the sag test only about 4 inches of sag was obtained after heating at 210° C. for 30 minutes. Moreover, the suitability of the composition for the production of thermoformed articles is evident from the following physical properties which were measured in accordance with conventional ASTM test procedures.

| Flexural Modulus (ASTM D 790): | | |
|---|---|---|
| Crosshead speed | 0.05 | in/min |
| 1% Secant modulus | 211700 | PSI |
| 2% Secant modulus | 168800 | PSI |
| Young's modulus | 234300 | PSI |
| Tensile Properties (ASTM D 638): | | |
| Yield | 3450 | PSI |
| Yield Elongation | 7.1% | |
| Break | 2570 | PSI |
| Break Elongation | 130% | |
| Dynatup (ASTM D 3763): | | |
| Temperature | −22° F. | |
| Impact velocity | 7.24 | ft/sec |
| Maximum load | 764 | lbs |
| Total energy | 31.64 | ft-lbs |
| Thickness | 125 | mils |
| Percent and type | 80% Ductile, | |
| of failure | 20% Brittle | |
| Izod Impact (ASTM D 256): | | |
| Complete failures impact resistance | 1.28 | ft-lbs/in |
| Complete failures impact resistance | 0.85 | ft-lbs/in |

TABLE I

| | | | | | | | Comp |
|---|---|---|---|---|---|---|---|
| | EX 2 | EX 3 | EX 4 | EX 5 | EX 6 | EX 7 | EX A |
| Propylene Polymer (wt. %) | 74 | 71.5 | 69 | 71 | 67 | 62 | 72 |
| Silane-Containing Polymer (wt. %) | 3 | 3 | 3 | 1 | 5 | 10 | 0 |
| Talc (wt. %) | 20 | 20 | 20 | 20 | 20 | 20 | 20 |
| Dispersion Aid (wt. %) | 0.5 | 0.5 | 0.5 | 0.5 | 0.5 | 0.5 | 0.5 |
| Plastomer (wt. %) | 2.5 | 5 | 7.5 | 7.5 | 7.5 | 7.5 | 7.5 |
| Time to 1″ Sag (mins) | 4 | 4 | 4 | 4 | 6 | >30 | 3 |
| Time to 2″ Sag (mins) | 8 | 11 | 12 | 6 | >30 | >30 | 5 |
| Time to 3″ Sag (mins) | >30 | >30 | >30 | 9 | >30 | >30 | 6 |
| Time to 4″ Sag (mins) | >30 | >30 | >30 | 12 | >30 | >30 | 7 |
| Time to 5″ Sag (mins) | >30 | >30 | >30 | 13 | >30 | >30 | 8 |
| Time to 6″ Sag (mins) | >30 | >30 | >30 | 14 | >30 | >30 | 9 |

We claim:

1. A propylene polymer composition having improved melt strength comprising:
(a) 50 to 99.5 weight percent, based on the total composition, of a propylene polymer having a melt flow rate from 0.01 to 50 g/10 min, and
(b) 0.5 to 50 weight percent, based on the total composition, of a silane-containing polymer wherein the silane functionality is incorporated by copolymerization or grafting, said silane-containing copolymer having a melt index from 0.05 to 50 g/10 min.

2. The composition of claim 1 wherein the propylene polymer is selected from the group consisting of propylene homopolymers and random, block, impact and TPO copolymers where propylene is the major monomer constituent.

3. The composition of claim 2 wherein the propylene polymer is a propylene-ethylene copolymer containing 55 to 99.5 weight percent propylene and 0.5 to 45 weight percent ethylene.

4. The composition of claim 1 wherein the silane polymer contains 0.1 to 20 weight percent vinyltrialkoxysilane of the formula H₂C═CHSi(OR)₃ where R is a C₁₋₄ alkyl group.

5. The composition of claim 4 wherein the silane-containing polymer is a high density polyethylene or low density polyethylene grafted with from 0.25 to 7.5 weight percent vinyltrimethoxysilane or vinyltriethoxysilane.

6. The composition of claim 4 wherein the silane polymer is a copolymer of ethylene and 0.25 to 7.5 weight percent vinyltrimethoxysilane or vinyltriethoxysilane.

7. The composition of claim 1 which additionally contains from 2 to 35 weight percent mineral filler selected from the group consisting of calcium carbonate, clay, talc, kaolinite, wollastonite, pyrophillite, magnesium hydroxide, oxides of zinc and magnesium, silica and silicates.

8. The composition of claim 7 wherein the mineral filler is talc having an average particle size between 0.2 and 10 microns.

9. The composition of claim 1 which additionally contains from 1 to 25 weight percent of an ethylene-C₄₋₈ α-olefin plastomer having a density of 0.86 to 0.92 g/cm³ and melt index from 0.1 to 50 g/10 min.

10. The composition of claim 9 wherein the plastomer is a copolymer of ethylene with butene-1, hexene-1 or octene-1 and has a density of 0.86 to 0.90 g/cm³ and melt index of 1 to 20 g/10 min.

11. The composition of claim 1 which additionally contains 0.01 to 1 weight percent of a dispersing aid selected from the group consisting of maleated polypropylenes; silanes; neoalkoxy titanates; fatty acid metal soaps; fatty acid amides; fatty acid esters and low molecular weight aliphatic resins.

12. The composition of claim 1 which additionally contains 0.001 to 0.5 weight percent of a promotor selected from the group consisting of dibutyltin dilaurate, dioctyltin maleate, dibutyltin diacetate, dibutyltin dioctoate, stannous acetate, stannous octoate, lead naphthenate, zinc caprylate and cobalt naphthenate.

13. A thermoplastic polyolefin composition useful for thermoforming and having improved melt strength comprising:
(a) 50 to 99.5 weight percent propylene-ethylene copolymer comprised of a crystalline propylene homopolymer phase and amorphous ethylene-propylene rubber phase, said copolymer having an ethylene content from 1 to 30 weight percent, ethylene-propylene rubber content from 2 to 50 weight percent, and melt flow rate from 0.01 to 50 g/10 min;
(b) 0.5 to 50 weight percent of a silane-containing polymer having 0.1 to 20 weight percent vinyltrimethoxysilane or vinyltriethoxysilane incorporated by copolymerization or grafting, said silane-containing polymer having a melt index from 0.05 to 50 g/10 min;
(c) 2 to 35 weight percent talc; and
(d) 1 to 25 weight percent of an ethylene-C₄₋₈ α-olefin plastomer having a density of 0.86 to 0.92 g/cm³ and melt index from 0.1 to 50 g/10 min;

14. The composition of claim 13 wherein (a) is a reactor-made intimate mixture of propylene homopolymer and ethylene-propylene rubber and (b) is a copolymer of ethylene and vinyltrimethoxysilane.

15. The composition of claim 14 wherein (c) has an average particle size from 0.2 to 10 microns and is present in an amount from 3 to 25 weight percent.

16. The composition of claim 15 wherein (d) is a copolymer of ethylene and butene-1, hexene-1 or octene-1 having a density of 0.86 to 0.90 g/cm³ and melt index of 1 to 20 g/10 min and is present in an amount from 3 to 15 weight percent.

17. The composition of claim 13 having a melt flow rate of 0.1 to 30 g/10 min.
